(19) United States
(12) Patent Application Publication
(10) Pub. No.: US 2020/0381963 A1
(43) Pub. Date: Dec. 3, 2020

(54) ELECTRIC MACHINE HAVING A STATOR GRATING COMPRISING AERODYNAMIC APPENDAGES

(71) Applicant: IFP Energies nouvelles, Rueil-Malmaison Cedex (FR)

(72) Inventors: Fabrice LE BERR, RUEIL-MALMAISON CEDEX (FR); Misa MILOSAVLJEVIC, RUEIL-MALMAISON CEDEX (FR); Luis Enrique MARTINEZ ALVARADO, RUEIL-MALMAISON CEDEX (FR); Veronique PENIN, RUEIL-MALMAISON CEDEX (FR)

(21) Appl. No.: 16/970,452

(22) PCT Filed: Jan. 23, 2019
(86) PCT No.: PCT/EP2019/051631

§ 371 Date: Aug. 17, 2020

(30) Foreign Application Priority Data
Feb. 16, 2018 (FR) 1851329

(51) Int. Cl. H02K 1/20; F02B 37/10; F04D 25/06

(52) U.S. Cl. CPC H02K 1/20; F04D 25/06; F02B 37/105

(57) ABSTRACT

The invention is an electrical machine, comprising a stator being radial passages (102) circumferentially arranged along the stator. These radial passages (102) are delimited by radial teeth (101) and magnetic flux generators are housed in these radial passages (102). Furthermore, radial passages (102) comprise fluid circulation galleries facing the magnetic flux generators. The electrical machine comprises at least one aerodynamic appendages (85, 90), coaxial with the electrical machine, and arranged at a longitudinal end of the electrical machine. Aerodynamic appendages (85, 90) comprise a first part for guiding the fluid passing through the circulation galleries, and a second part extending radially along at least one of radial teeth (101) and having an aerodynamic profile for guiding the fluid.

### CROSS-REFERENCE TO RELATED APPLICATIONS

Reference is made to International Application No. PCT/EP2019/051631, filed Jan. 23, 2019, which claims priority to French Patent Application No. 18/51.329, filed Feb. 16, 2018, the contents of which are incorporated herein by reference in their entirety.

### BACKGROUND OF THE INVENTION

### Field of the Invention

The present invention relates to an electrically-assisted compression device for a working fluid such as a liquid fluid or a gaseous fluid.

It notably relates to a device for compressing a gaseous fluid, air here, by a compressor, alone or associated with a turbine to form a turbocharger, prior to sending it to any device and, more particularly, to the intake of an internal-combustion engine.

### Description of the Prior Art

Indeed, as is widely known, the power delivered by an internal-combustion engine depends on the amount of air fed to the combustion chamber of this engine, with the amount of air is itself being proportional to the density of this air.

Thus, it is usual to increase this amount of air through compression of the outside air before it is allowed into this combustion chamber when high power is required. This operation, known as turbocharging, can be carried out using any means, such as a compressor alone, electrically driven by an electrical machine (electrified compressor), or a compressor associated with a turbine and an electrical machine to form an electrified turbocharger.

In the aforementioned two cases, the electrical machine associated with the compressor can be of several types.

One is an electrical machine with a small air gap and windings close to the rotor, which provides optimal guidance of the magnetic flux and optimized efficiency. This type of electrical machine has the advantage of a certain compactness, which may sometimes be a problem regarding cooling thereof and requires a specific system for carrying off heat losses.

In order not to be intrusive on the air intake of the compressor, this type of electrical machine is conventionally positioned on the back of the centrifugal compressor in the case of an electrified compressor, or between the compressor and the turbine in the case of an electrified turbocharger, despite the presence of an unfavorable thermal environment in the latter case, since close to the turbine. Generally, the link between the compressor, the turbine and the electrical machine is rigid. This type of machine can also be positioned on the compressor side, but relatively far from the air intake not to disturb it. The link between the compressor and the machine is then rigid or consisting of a mechanical or magnetic coupling.

This type of systems is described in more detail in patents and published patent applications: US-2014/0,373,532, U.S. Pat. Nos. 8,157,543, 8,882,478, US-2010/0,247,342, U.S. Pat. Nos. 6,449,950, 7,360,361, and EP-0,874,953 or EP-0,912,821.

Another type of machine is the electrical machine with a large air gap, which may sometimes be several centimeters long to allow passage of the working fluid therethrough, thus enabling integration as close as possible to the compression systems, in a significantly more favorable thermal environment.

This electrical machine arrangement however has the drawback of disturbing and limiting passage of the magnetic flux between the rotor and the stator through the large air gap, which contributes to limiting the intrinsic efficiency of the electrical machine and the specific performances thereof (specific power, power density).

This type of electrical machine is notably described in patents EP-1,995,429, US-2013/169,074 and US-2013/043,745.

Finally, a new type of machine has recently appeared. It is a machine provided with a stator grid, which is described in more detail in patent applications FR-3,041,831 (WO-2017/050,577) and FR-3,048,022. This electrical machine, referred to as “stator-grid” machine, comprises a rotor and a stator. The stator comprises a multiplicity of radial passages circumferentially arranged along the stator, magnetic flux generators housed in these radial passages and a stator bearing receiving the rotor. The magnetic flux generators are coils for example. The radial passages comprise fluid circulation galleries facing the magnetic flux generators. Furthermore, the radial passages are separated by radial teeth, also referred to as “stator teeth”.

This machine affords the advantage of providing a better compromise in terms of cooling and electrical performances than the other two types of machine. On the other hand, the planar faces of the stator teeth at the ends of the machine are perpendicular to the air flow and they can therefore disturb the flow. The impact on the air flow results in a decrease in the compressor performance. Besides, modifying the shape of the radial teeth to improve the air flow would generate a higher cost of the machine. Indeed, the stator including these teeth is made from a stack of metal strips (thin plates). In order to modify the shape of the stator teeth, a specific geometry is required on each strip or a particular strip assembly would be necessary, which would make manufacture more complex, have a negative impact on the cost of the final system and the logistics, notably for identifying each strip independently.

### SUMMARY OF THE INVENTION

To overcome the aforementioned drawbacks, the present invention relates to an electrical machine with a stator grid, comprising a rotor and a stator that includes radial passages circumferentially arranged along the stator. The radial passages are delimited by radial teeth, and magnetic flux generators are housed in the radial passages. Furthermore, the radial passages comprise fluid circulation galleries facing the magnetic flux generators. To improve passage of the fluid (air for example) through the machine, the electrical machine comprises at least one aerodynamic appendage, coaxial with the electrical machine and arranged at a longitudinal end of the electrical machine. This aerodynamic appendage comprises at least two parts: the first part serves to guide the fluid passing through the circulation galleries; the second part extends radially along the radial teeth and it has, in the axial direction of the electrical machine, an aerodynamic profile for guiding the fluid.

The invention also relates to a compression device equipped with such an electrical machine and a turbocharger electrified with this type of machine.

The device according to the invention relates to an electrical machine comprising a rotor and a stator that includes radial passages circumferentially arranged along the stator. The radial passages are delimited by radial teeth with magnetic flux generators being housed in the radial passages, which radial passages comprise fluid circulation galleries facing the magnetic flux generators. The electrical machine comprises at least one aerodynamic appendage, which is coaxial with the electrical machine, and is arranged at a longitudinal end of the electrical machine. The aerodynamic appendage comprises at least a first part for guiding the fluid passing through the circulation galleries and at least a second part, extending radially along at least one of the radial teeth and having, in the axial direction of the electrical machine, an aerodynamic profile for guiding the fluid.

Advantageously, the aerodynamic appendage is made from a material with low thermal resistance, preferably a polymer material, and more preferably a polymer material allowing complex shapes to be formed.

Preferably, the fluid is air.

Advantageously, the aerodynamic appendage has an asymmetrical profile along the median plane of the aerodynamic appendage.

According to a variant of the invention, the aerodynamic appendage is obtained by additive manufacturing or by moulding.

According to an embodiment of the invention, the aerodynamic appendage is made of at least two elements, with at least one removable element.

Advantageously, the electrical machine comprises two aerodynamic appendages arranged at both longitudinal ends of the electrical machine.

Preferably, the second part of the aerodynamic appendage, when the aerodynamic appendage is positioned at the longitudinal end of the radial teeth located at the inlet of the fluid in the circulation galleries, substantially has a semi-circular profile in a section orthogonal to the radial direction of the radial teeth.

Preferably, the aerodynamic appendage, positioned at the longitudinal end of the radial teeth located at the inlet of the fluid in the circulation galleries, comprises a central ogive, preferably the ogive is of elliptical shape of order at least three.

Advantageously, the ogive comprises openings allowing passage of the fluid.

According to an embodiment of the invention, the openings of the ogive advantageously guide the air flow in the air gap to minimize disturbances and the amount of air passing through the air gap.

Preferably, the openings of the ogive serve as a protection against debris with the size of the openings being smaller than the thickness of the air gap.

According to a variant of the invention, the second part of the aerodynamic appendage, when the aerodynamic appendage is positioned at the longitudinal end of the radial teeth located at the outlet of the fluid from the circulation galleries, is a profile whose thickness, in a section perpendicular to the radial direction of the radial teeth, decreases longitudinally with the greatest thickness being located at the longitudinal end of the radial teeth.

Preferably, the aerodynamic appendage positioned at the longitudinal end of the radial teeth, located at the outlet of the fluid from the circulation galleries, has a longitudinal dimension that varies depending on the radial position thereof, preferably, the longitudinal dimension decreases when the radial position increases.

According to a variant of the invention, the aerodynamic appendage positioned at the longitudinal end of the radial teeth, located at the outlet of the fluid from the circulation galleries, is equipped with mobile aerodynamic flaps and with an associated control system, the mobile aerodynamic flaps being for giving an advantageous direction to the fluid at the outlet of the electrical machine or to regulate the flow rate of the fluid.

The invention also relates to a compression device for a gaseous or liquid fluid, comprising a compressor with an intake for the fluid to be compressed, an outlet for the compressed fluid, the means for compressing the fluid being carried by a compressor shaft and housed between the intake and the outlet, and an electrical machine according to one of the above features, the electrical machine being positioned upstream, in relation to the direction of flow of the fluid, from the compressor.

Moreover, the invention relates to an electrified turbocharger device comprising an expansion device or means and a compression device, according to one of the above features, the expansion means or device and the compression device being fastened to the same rotating shaft, thus allowing common rotation of the expansion means or device and the compression device.

### BRIEF DESCRIPTION OF THE DRAWINGS

Other features and advantages of the device according to the invention will be clear from reading the description hereafter of embodiments, given by way of non limitative example, with reference to the accompanying figures wherein:

FIG. 1 schematically illustrates the arrangement of an electrified compression device according to an embodiment of the invention;

FIG. 2 schematically illustrates the arrangement of an electrified turbocharger according to an embodiment of the invention;

FIG. 3 is a perspective view of the stator grid;

FIG. 4 illustrates a circumferential cross-section at the stator teeth of a perspective view of an embodiment of an assembly, according to the invention, of the stator grid equipped with two aerodynamic appendages;

FIG. 5 illustrates a perspective view of an assembly, according to an embodiment of the invention, of the stator grid and of the upstream aerodynamic appendage, at the fluid inlet in the stator grid;

FIG. 6 illustrates a perspective view of an assembly, according to an embodiment of the invention, of the stator grid and of the downstream aerodynamic appendage, at the fluid outlet of the stator grid;

FIG. 7 is an exploded view of an embodiment of an assembly, according to the invention, of the upstream aerodynamic appendage, at the fluid inlet of the stator grid, of the stator grid itself and of the downstream aerodynamic appendage, at the fluid outlet of the stator grid;

FIG. 8 is a perspective view of a variant of the aerodynamic appendage arranged downstream from the stator grid, at the fluid outlet of the stator grid, according to an embodiment of the invention;

FIG. 9 is a perspective view of a variant of the aerodynamic appendage arranged upstream from the stator grid, at the fluid inlet of the stator grid, according to an embodiment of the invention;

FIG. 10a illustrates a variant of an embodiment according to the invention, viewed in a longitudinal section at the stator teeth, with an aerodynamic appendage, at the stator grid outlet, of constant length according to the radial position; and

FIG. 10b illustrates a variant of an embodiment according to the invention, viewed in a longitudinal section at the stator teeth, with an aerodynamic appendage, at the stator grid outlet, of variable length depending on the radial position.

### DETAILED DESCRIPTION OF THE INVENTION

The invention relates to an electrical machine comprising a rotor and a stator. The stator comprises a radial passages circumferentially arranged along the stator. The radial passages are delimited by radial teeth, and magnetic flux generators are housed in the radial passages. The magnetic flux generators are coils for example. Furthermore, the radial passages comprise fluid circulation galleries facing the magnetic flux generators.

Moreover, the electrical machine comprises at least one aerodynamic appendage, coaxial with the electrical machine and arranged at a longitudinal end of the electrical machine. This aerodynamic appendage comprises at least a first part for guiding the fluid passing through the circulation galleries and at least a second part extending radially along at least one of the radial teeth and having, in the axial direction of the electrical machine, an aerodynamic profile for guiding the fluid. Using this aerodynamic appendage allows better channeling of the fluid flow by use of the first guiding part of the aerodynamic appendage on the one hand, and prevents disturbance of the flow through the stator teeth passages, by use of the second profiled part of the aerodynamic appendage on the other hand.

By way of example only, in the rest of the description, this machine is a one-pole-pair synchronous machine.

This does not in any way exclude any other electrical machine, such as synchronous machines with more than one pole pair, wound-rotor or squirrel-cage-rotor asynchronous machines, and reluctance machines.

According to an embodiment, the aerodynamic appendage can be made from a material with low thermal resistance, preferably a polymer material. Thus, cooling of the stator grid is improved, the low thermal resistance involving a material with good thermal conductivity. Preferably, the polymer material can be compatible with an additive manufacturing machine or with a moulding process allowing complex shapes to be formed.

According to another variant of the invention, the aerodynamic appendage can have an asymmetrical profile along the median plane thereof. This specific feature has the advantage of modifying the direction of flow for example, and it can be of real interest for example for directing the fluid flow at the outlet to a next accessory, such as a compressor for example, in order to improve its performance.

Preferably, the aerodynamic appendage can be made by additive manufacturing or by moulding. The cost of the aerodynamic appendage can thus be reduced. Moulding is particularly interesting for mass-produced parts because this manufacturing technique enables fast and inexpensive production. Additive manufacturing allows complex parts to be produced, notably parts that cannot be made by moulding.

According to a variant embodiment of the invention, the aerodynamic appendage can be made of at least two elements, with at least one removable element. Indeed, the fluid flow can be laden with aggressive fluid or solid elements likely to damage the aerodynamic appendage. Making at least part of the appendage in contact with the potentially laden fluid removable allows replacement it and maintaining the electrical and thermal performances of the electrical machine while increasing its life. Since part of the aerodynamic appendage is not in contact with the fluid, this part can be kept throughout the life of the electrical machine.

Preferably, the electrical machine can comprise two aerodynamic appendages arranged at both longitudinal ends of the electrical machine. Thus, the fluid flow is channeled as the fluid flows into and out of the stator grid, which allows improvement of the performance and cooling of the electrical machine, to limit pressure drops and to optimize the performance of a component likely to be arranged at the outlet, such as a compressor for example.

According to a variant of the invention, the second part of the aerodynamic appendage, when it is positioned at the longitudinal end of the radial teeth located at the fluid inlet of the circulation galleries, can substantially have a semi-circular profile in a section orthogonal to the radial direction of the radial teeth. This aerodynamic profile of semi-circular section allows limiting of the risk of flow disturbance at the fluid inlet of the stator grid.

According to a variant of the invention, the aerodynamic appendage, positioned at the longitudinal end of the radial teeth located at the fluid inlet of the circulation galleries, can comprise a central ogive. The ogive has the shape of a body of revolution, with an increasing diameter in the longitudinal direction and in the direction of circulation of the fluid, so as to direct the flow progressively. Preferably, the ogive is of elliptical shape of at least order three. The ogive allows the flow to be oriented in the circulation galleries, limiting as much as possible flow disturbances in this zone. This feature is particularly verified when the ogive is of elliptical shape of at least order three in the longitudinal direction. The ogive also affords the advantage of protecting the rotor and the air gap from the fluid flow and from possible solid elements that might degrade the rotor or the air gap, and thus degrade the performance of the electrical machine. The ogive is coaxial with the rotor and at least one of the rotating shaft and the stator of the electrical machine. Preferably, the ogive, at its end closest to the stator grid, has a substantially cylindrical outer shape, preferably with a diameter greater than the rotor diameter.

According to a variant of this embodiment, when the aerodynamic appendage comprises an ogive, which can comprise openings allowing passage of a fluid through the air gap. Preferably, this embodiment can be used when the heat-transfer fluid comprises no aggressive chemical or mechanical elements (solid particles for example) likely to deteriorate at least one of the rotor and the air gap. Allowing passage of the fluid through the air gap by use of openings in the ogive provides better cooling of the rotor and therefore allows maintaining the performance of the electrical machine while minimizing the pressure drops of the entire flow. Preferably, the size of these openings is smaller than the thickness of the air gap, to prevent debris from passing through the air gap and clogging it.

Alternatively, the aerodynamic appendage, positioned at the longitudinal end of the radial teeth located at the fluid inlet of the circulation galleries, can comprise an inner crown in form of an inner ring or a solid disc, instead of the ogive described above. This inner crown allows connection of the aerodynamic profile walls to each other and thus to mechanically reinforce the aerodynamic appendage.

Using a solid disc for the inner crown prevents the fluid from entering the air gap. If this fluid is laden with aggressive chemical or mechanical agents (solid particles for example), the solid disc allows the rotor and the air gap to be protected from these agents.

On the other hand, using an inner ring for the inner crown, the inner ring being characterized by a non-zero outside diameter and inside diameter, allows the fluid to enter the air gap. This specific feature allows improvement cooling of the rotor and improves the performance of the electrical machine. This is particularly interesting when the fluid is free of aggressive chemical or mechanical agents (solid particles for example).

According to another variant of the invention, the second part of the aerodynamic appendage, when positioned at the longitudinal end of the radial teeth located at the fluid outlet of the circulation galleries, can be a profile whose thickness, in a section perpendicular to the radial direction of the radial teeth, can decrease longitudinally, the greatest thickness being at the longitudinal end of the radial teeth. This aerodynamic profile of tapered section and progressively decreasing thickness allows limiting risk of flow disturbance at the fluid outlet of the stator grid. This profile can notably end in a point in order to reattach the flows coming from two adjacent circulation galleries, by limiting as much as possible disturbances and pressure drops.

Preferably, the aerodynamic appendage positioned at the longitudinal end of the radial teeth located at the fluid outlet of the circulation galleries can have a variable longitudinal dimension depending on the radial position thereof. Preferably, the longitudinal dimension can decrease when the radial position increases. Thus, the aerodynamics at the radial teeth outlet are improved because the flow can reattach while limiting aerodynamic disturbances.

According to a variant of the invention, the aerodynamic appendage positioned at the longitudinal end of the radial teeth located at the fluid outlet of the circulation galleries can be equipped with mobile flaps and with an associated control system, the mobile flaps allowing the aerodynamic profile to be modified at the outlet of the electrical machine. This function allows optimizing the direction of flow of the fluid according to the electrical machine, the compressor and the expected overall system performance.

The invention also relates to a compression device for a gaseous or liquid fluid, comprising a compression means (compressor for example) with an intake for the fluid to be compressed and an outlet for the compressed fluid. The fluid compressor is carried by a compressor shaft and housed between the intake and the outlet. The device also comprises an electrical machine according to one of the above embodiments, the electrical machine being positioned upstream, in relation to the direction of flow of the fluid, from the compressor. Using the electrical machine described above for an electrified compressor allows the cooling performance of the electrical machine to be improved, thus increasing the performance and the life thereof, while providing the compressor with a fluid circulation flow that minimizes pressure drops within the electrical machine, and limiting aerodynamic disturbances at the compressor outlet, thus allowing the compression performance to be improved.

The invention further relates to an electrified turbocharger device comprising an expansion device or means (turbine for example) and an electrified compression device as defined above. The expansion device means and the compression device are fastened to the same rotating shaft, thus allowing common rotation of the expansion device or means and of the compression device. Using the electrified compression defined above allows the compression performance to be improved and the turbocharger performance is therefore also higher with the fluid flow rate at the turbine inlet being increased due to the compressor performance increase.

Moreover, the compressor can be equipped with a ported shroud allowing recirculation of part of the gas compressed by the compressor upstream from the compressor. This recirculation of part of the compressed gas prevents surge phenomena likely to occur under some operating conditions (low flow rate, high pressure difference between the compressor inlet and outlet) and to lead to instationary reversal of the direction of flow in the compressor. When it occurs, surge can cause very significant damage to the compressor.

When the compressor is equipped with a ported shroud, a trailing edge for which the length of aerodynamic profile wall 92 of the downstream aerodynamic appendage 90 decreases when its radial position increases is particularly advantageous. Indeed, the reduced length at the outside diameter allows a decrease in the wake on the outer radius and thus prevents untimely operation of the ported shroud when unnecessary, thereby improving the compressor efficiency. Keeping a greater length on the inside diameter allows, on the other hand prevention of wake disturbance at the compressor inlet.

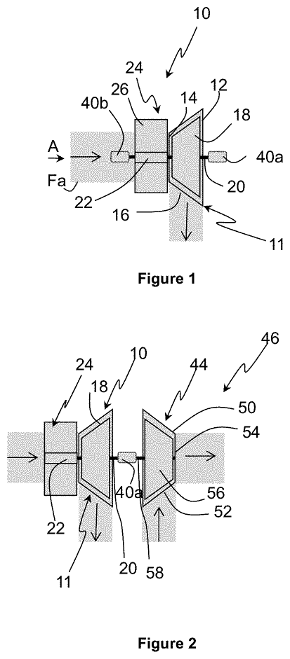

FIG. 1 schematically illustrates, by way of non-limitative example, an electrically-assisted compression device 10 for a working fluid such as a liquid fluid or a gaseous fluid.

This device is used in particular as a compressor for a fluid controlled by an electrical machine and it is referred to as electrified compressor hereafter.

Compressor 11, which as illustrated is a centrifugal impeller compressor for example, comprises a casing 12 with an intake 14 for a gaseous fluid such as air or an air mixture (that can contain exhaust gas) and a compressed fluid outlet 16.

This casing 12 houses a compression means or device in a form of a compressor wheel 18 arranged between the intake and the outlet, which is subjected to a rotational motion on a shaft 20.

This shaft 20 is rotationally connected to a rotor 22 of an electrical machine 24 arranged opposite intake 14 and upstream therefrom with respect to the gaseous fluid stream Fa circulating from left to right in FIG. 1.

As described hereafter, the electrical machine used as the motive machine has the specific feature of being configured so that the gaseous fluid flows through the stator of this machine and is fed to intake 14 of the compressor.

In the example of FIG. 1, the electrical machine which is arranged on intake 14 to which it is fastened in any known way, such as with screws.

FIG. 2 schematically illustrates, by way of non-limitative example, a compression device 10 for a gaseous or liquid fluid that is associated with an expansion device 44.

The assembly thus formed is known as a turbocharger 46.

As in FIG. 1, compression device 10 comprises a compressor 11 and an electrical machine 24 whose rotor 22 is connected to shaft 20 of wheel 18 of the compressor.

Expansion device 44 comprises a turbine with a casing 50 carrying an inlet 52 for a fluid (compressed hot air for example, or exhaust gas from an internal-combustion engine) and an expanded fluid outlet 54. A turbine wheel 56, illustrated as an impeller, is arranged in casing 50 between the inlet and the outlet, and it is carried by a turbine wheel shaft 58. This shaft 58 is rotationally connected to the assembly made up of rotor 22 of the electrical machine and shaft 20 of the compressor wheel.

Rotor 22, compressor wheel shaft 20 and turbine wheel shaft 58 thus make up a monoblock assembly supported by a bearing 40a.

For this example in FIG. 2, the compressor can thus be driven by the turbine alone, and the electrical machine can then act as a current generator in response to the rotation of rotor 22 if the power supplied by the turbine is greater than the power required for operating the compressor.

The compressor can also be driven by the turbine and the electrical machine used as electrical motor, which allows increasing the dynamic and static performances of the turbocharger, notably to increase the compression ratio for a given expansion ratio and to promote activation and revving of the compressor (turbocharger response time reduction).

It is noted that a surface treatment of the stator and the rotor makes this machine compatible with the supply of a corrosive fluid, such as the exhaust gas from an engine that can be mixed with air.

Furthermore, this type of machine can notably be integrated rather simply to an existing turbocharger system without requiring profound changes to the original system.

In this type of architecture, the rotor of the electrical machine can notably act as a clamping nut on the compressor side.

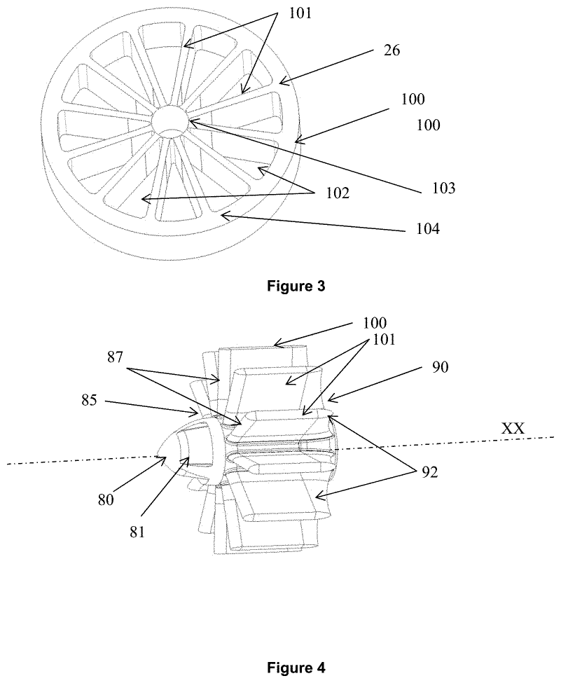

FIG. 3 schematically illustrates, by way of non-limitative example, an example of a stator grid 100 of a stator-grid electrical machine, which is described in more detail in patent applications FR-3,041,831 (WO-2017/050,577) and FR-3,048,022. Stator grid 100 comprises radial teeth 101 (also referred to as stator teeth) and radial fluid passages 102 (for example 12 radial passages and 12 radial teeth in the non-limitative example of FIG. 3). These radial passages 102 serve both as circulation galleries for the working fluid and for mounting the coils. Stator teeth 101 extend from a central ring 103, which may be continuous or discontinuous, with slots for example, to an outer ring 104. The surfaces at the longitudinal ends of inner ring 103 and outer ring 104, as well as the surfaces at the longitudinal ends of radial teeth 101, are planar and coplanar, thus forming surfaces 26. The radial passages are delimited by the inner 103 and outer 104 rings, and by radial teeth 101.

FIG. 4 schematically illustrates, by way of non-limitative example, a circumferential cross-section of an assembly having stator grid 100, an aerodynamic appendage 85 according to an embodiment of the invention, upstream from the fluid inlet (air for example) in stator grid 100, and of an aerodynamic appendage 90 according to an embodiment of the invention, downstream from the fluid outlet in stator grid 100. The first parts of aerodynamic appendages 85 and 90 are intended to guide the circulating fluid flow which is not shown in FIG. 4. Axis XX represents the longitudinal axis of the electrical machine, common to the axis of the stator and the axis of the rotor and the axis of aerodynamic appendages 85 and 90. This circumferential cross-section notably provides a view of the overall profile of the assembly at the stator teeth. This overall profile comprises a rounded profile 87, semi-circular for example, on upstream aerodynamic appendage 85, the section, rectangular or of constant thickness for example, of stator teeth 101 of stator grid 100, and a tapered profile 92, whose thickness decreases progressively (ellipse of order 3 and more), on downstream aerodynamic appendage 90. The end of tapered profile 92 can be rounded or pointed to improve the reattachment of the flows from different adjacent circulation galleries. In FIG. 4, tapered profile 92 on aerodynamic appendage 90 which is located downstream has a variable longitudinal dimension (length) depending on the radial position.

Upstream aerodynamic appendage 85 also comprises a central ogive 80 which is coaxial with the stator and stator grid 100. This ogive 80 extends from stator grid 100, where it is substantially cylindrical and of greater radius than the rotor radius which is in the longitudinal direction is opposite to the direction of flow of the fluid. The end can be pointed, as shown in FIG. 4, or rounded. Thus, the incoming flow first encounters ogive 80, at the point or the rounded end thereof. The circulating flow is then guided by the outer wall of ogive 80 towards the fluid circulation galleries delimited by radial teeth 101.

Ogive 80 is provided, in the example of FIG. 4, with openings 81 allowing passage of the fluid into ogive 80 in order to cool the rotor and the air gap. This configuration is notably relevant when the heat-transfer fluid is free of aggressive chemical agents and solid particles likely to damage at least one of the rotor and the air gap.

When the heat-transfer fluid is laden with aggressive chemical agents or solid particles likely to damage the rotor or the air gap, ogive 80 preferably has no openings 81. Thus, the fluid cannot enter the air gap zone, and the air gap and the rotor are therefore protected.

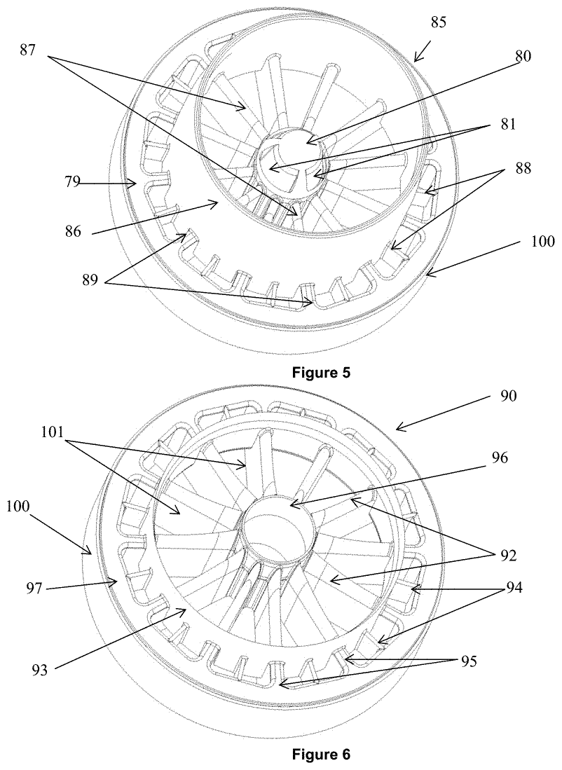

FIG. 5 schematically illustrates, by way of non-limitative example, an embodiment of upstream aerodynamic appendage 85 (whereas FIG. 4 is a circumferential cross-section at the teeth) mounted on stator grid 100. The aerodynamic appendage is provided, in addition to aerodynamic profile 87 upstream from the teeth, with a cylindrical wall 86 for guiding the circulating fluid flow inside this wall. The circulating fluid flow thus passes entirely through the conduit defined by the inside diameter of cylindrical wall 86. This cylindrical wall 86 also allows isolating the windings from direct contact with the fluid.

Aerodynamic appendage 85 can also comprise a central ogive coaxial with the stator. Ogive 80 may, or not, comprise openings 81 for passage of the circulating fluid flow (air for example) towards the air gap and the rotor (not shown in FIG. 5), and thus for cooling the rotor. The ogive is fixed with aerodynamic profiles 87 covering radial teeth 101. Thus, the ogive contributes to the rigidity of the assembly.

When no ogive is used, an inner crown can be utilized instead. The purpose of this inner crown is then to connect the aerodynamic profiles 87 covering radial teeth 101 over the inside diameter thereof to ensure the rigidity of the entire aerodynamic appendage 85.

No flow circulates outside this cylindrical wall 86. On the other hand, aerodynamic appendage 85 is provided with radial walls 89 covering the radial teeth. These radial walls 89 as located outside the space delimited by cylindrical wall 86 in the extension of aerodynamic profile walls 87. Furthermore, aerodynamic appendage 85 is provided with radial walls 88 which are complementary to radial walls 89 covering the radial teeth. These radial walls 88 serve to delimit the coil spaces (not shown) surrounding the radial teeth. Radial walls 88 and 89 are held together, on the outside diameter thereof, by an outer crown 79. The outer crown rests against one of these longitudinal ends on surface 26 of stator grid 100. This end thus is a planar surface providing optimum contact. The other end of this outer crown 79 is also a planar surface, coplanar with the longitudinal end of radial walls 89.

The part of aerodynamic appendage 85 delimited by cylindrical wall 86 is subjected to a circulating flow that might damage it. It may be desirable to ensure that this part of aerodynamic appendage 85 comprising cylindrical wall 86, the walls of aerodynamic profile 87 covering radial teeth 101 and the inner crown (not shown) or ogive 80, if any, is removable so as to be replaced if needed.

The outer part of cylindrical wall 86 may optionally be non-removable. Thus, aerodynamic appendage 85 can have two parts which are a removable first part comprising cylindrical wall 86, the inner crown or ogive 80, if any, and aerodynamic profile walls 87 covering radial teeth 101 and a non-removable second part comprising outer crown 79 and radial walls 88 and 89.

The geometric connection areas have connection fillets or chamfers to avoid fluid circulation disturbances.

FIG. 6 schematically illustrates, by way of non-limitative example, an embodiment of a downstream aerodynamic appendage 90 (whereas in FIG. 4 it is a circumferential cross-section at the teeth) mounted on stator grid 100. Aerodynamic appendage 90 comprises, in addition to aerodynamic profile 92 downstream from radial teeth 101, a cylindrical wall 93 for guiding the fluid flow leaving the fluid circulation galleries, delimited by radial teeth 101, inside this cylindrical wall 93. The circulating flow leaving the fluid circulation galleries thus flows entirely through the conduit defined by the inside diameter of cylindrical wall 93.

Aerodynamic appendage 90 also comprises an inner cylindrical wall 96 providing mechanical strength and connection of aerodynamic profile walls 92 with one another.

No flow circulates outside this cylindrical wall 93. On the other hand, aerodynamic appendage 90 is provided with radial walls 95 covering the radial teeth. The radial walls 95 are located outside the space delimited by cylindrical wall 93 and in the extension of aerodynamic profile walls 92. Furthermore, aerodynamic appendage 90 is provided with radial walls 94 which are complementary to radial walls 95 covering the radial teeth. These radial walls 94 serve to delimit the coil spaces (not shown) surrounding the radial teeth.

Moreover, aerodynamic appendage 90 comprises an outer crown 97, which may be cylindrical for example, whose diameter is substantially equal to the diameter of stator grid 100. The longitudinal ends of this outer crown 97 are planar. On one side, it is in contact with the surface of stator grid 100. The other planar surface end of outer crown 97 is coplanar with the longitudinal end of radial walls 95. This crown allows holding together all the radial walls 92 and 95, in the extension of walls 92, and radial walls 94. Thus, the mechanical strength of aerodynamic appendage 90 as a whole is ensured.

The part of aerodynamic appendage 90 delimited by cylindrical wall 93 is subjected to a circulating flow that might damage it. It may be interesting to ensure that this part of the aerodynamic appendage comprising cylindrical wall 93, aerodynamic profile 92 covering the radial teeth and inner cylindrical wall 96 is removable so as to be replaced if need be.

The outer part of cylindrical wall 93 may optionally be non-removable. Thus, aerodynamic appendage 90 can two parts which are a removable first part comprising cylindrical wall 93, inner cylindrical wall 96 and aerodynamic profile walls 92 covering radial teeth 101 and a non-removable second part comprising outer crown 97 and at least one of radial walls 94 and 95.

It is also noted that the geometric connection areas have connection fillets or chamfers to avoid fluid circulation disturbances.

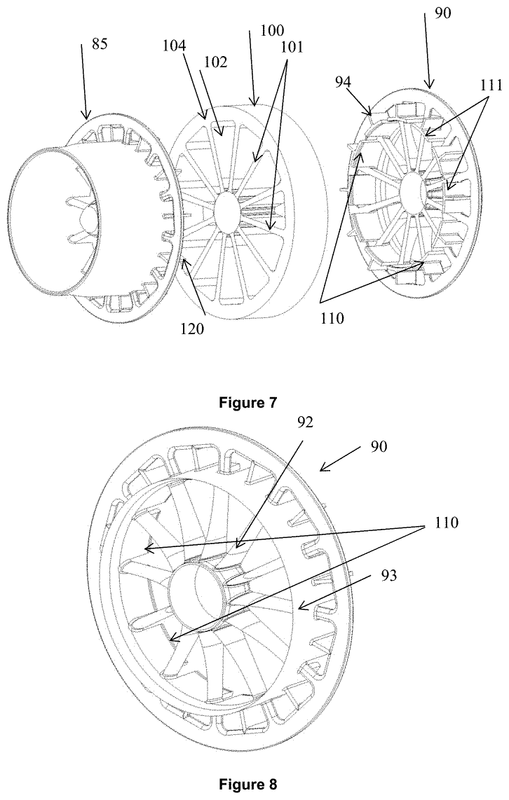

FIG. 7 schematically shows, by way of non-limitative example, an exploded view of an assembly, according to an embodiment of the invention, of stator grid 100 and of two aerodynamic appendages 85 and 90 which are respectively arranged upstream and downstream from stator grid 100, with respect to the direction of flow of the fluid. The two appendages correspond to those described in connection with FIGS. 5 and 6.

These two aerodynamic appendages 85 and 90 are equipped with mounting members 110 and 120, which are directly integrated in aerodynamic appendages 85 and 90. Mounting members 110 allow aerodynamic appendage 90 to be mounted in stator grid 100. These mounting members 110 engage radial webs 102 in the outer part, which is delimited by outer ring 104 and stator teeth 101. Mounting member 110 comprises an extension of radial walls 94, in the longitudinal direction extending from the outer end towards the inside, in the opposite direction to the direction of flow so that these radial walls 94 engage into radial webs 102.

Mounting member 110 also is a portion of a cylindrical wall 111, radial wall 94 and cylindrical wall 111 forming a substantially T-shaped section. Cylindrical wall portion 111 extends cylindrical wall 93, in the longitudinal direction, opposite to the flow, to enter radial webs 102 of stator grid 100. The junction between radial wall 94 and cylindrical wall 111 forming the T-shaped section is achieved at the inner radial end of radial wall 94 and approximately at circumferential mid-length of cylindrical wall portion 111. The number of mounting members 110 is equal to the number of radial webs 102 of stator grid 100 (12 mounting members 110 in FIG. 7).

Mounting members 110 allow aerodynamic appendage 90 to be positioned on stator grid 100 and prevent any relative rotation of these two parts as relative rotation of the parts might disturb the circulating fluid flow.

Mounting members 110 are an integral part of aerodynamic appendage 90.

Mounting members 120 of aerodynamic appendage 85 are substantially symmetrical to mounting members 110 of aerodynamic appendage 90 with respect to the median plane of stator grid 100 which is orthogonal to the longitudinal axis.

FIG. 8 schematically illustrates, by way of non-limitative example, aerodynamic appendage 90 of FIGS. 6 and 7, alone, unlike in FIG. 6 where it is shown as being mounted on stator grid 100. FIG. 8 allows visualizing of the one hand aerodynamic profile 92 and outer part 93 of the aerodynamic appendage, and, mounting members 110 that enter stator grid 100 which are not shown in FIG. 6.

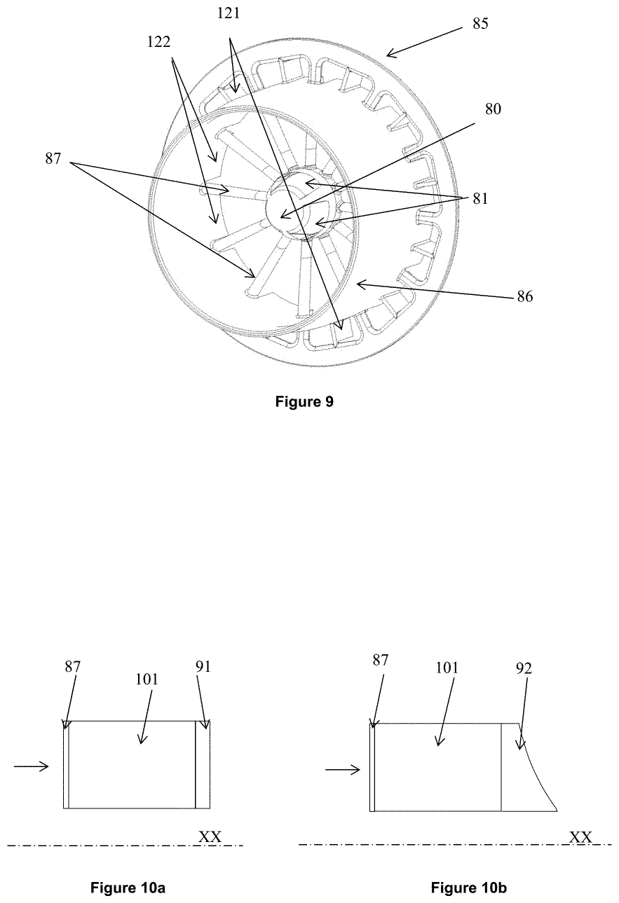

FIG. 9 schematically shows, by way of non-limitative example, aerodynamic appendage 85 of FIGS. 5 and 7, alone, unlike FIG. 5 where aerodynamic appendage 85 is shown mounted on stator grid 100. Aerodynamic stator appendage comprises aerodynamic profiles 87, an outer part 86, an ogive 80 provided with openings 81. Moreover, FIG. 9 allows being able to see that mounting members 120 comprise radial walls 121 extending radial walls 88, in the direction of the flow, to enter stator grid 100, radial walls 121 being similar to walls 94 of mounting members 110, and cylindrical wall portions 122 longitudinally extending cylindrical wall 87 in the direction of flow, which enters the stator grid. Cylindrical wall portions 122 are similar to cylindrical wall portions 111 of mounting members 110. Mounting members 120 are similar to mounting members 110. Radial walls 121 and cylindrical wall portions 122 form a substantially T-shaped section. The junction between radial wall 121 and cylindrical wall 122 is achieved at the inner radial end of radial wall 121 at approximately a circumferential mid-length of cylindrical wall portion 122. The number of mounting members 120 is equal to the number of radial webs 102 of stator grid 100 (12 mounting members 120 for example).

Mounting members 120 allow aerodynamic appendage 85 to be positioned on stator grid 100 and prevent any relative rotation of these two parts as relative rotation of the parts might disturb the circulating fluid flow.

Mounting members 120 are an integral part of aerodynamic appendage 85.

FIG. 10a schematically shows, by way of non-limitative example, a section in a plane defined by the longitudinal axis XX of the electrical machine (horizontal axis) and by a radial axis of a radial tooth 101 of an embodiment according to the invention.

This figure shows aerodynamic profile wall 87 of upstream aerodynamic appendage 85, stator tooth 101 and aerodynamic profile wall 91 of downstream aerodynamic appendage 90. In this configuration, each of these three parts has a constant length, along longitudinal axis XX, as a function of the radial position of the part being considered. Furthermore, the longitudinal end surfaces of aerodynamic profile wall 87 of upstream aerodynamic appendage 85, of stator tooth 101 and of aerodynamic profile wall 91 of downstream aerodynamic appendage 90 are all perpendicular to axis XX. Notably, aerodynamic profile wall 91 ends in a straight part orthogonal to axis XX and to the direction of flow.

FIG. 10b schematically shows, by way of non-limitative example, a section in a plane defined by longitudinal axis XX of the electrical machine (horizontal axis) and by a radial axis of a radial tooth 101 of an embodiment according to the invention.

This figure shows aerodynamic profile wall 87 of upstream aerodynamic appendage 85, stator tooth 101 and aerodynamic profile wall 92 of downstream aerodynamic appendage 90. In this configuration, aerodynamic profile wall 87 of upstream aerodynamic appendage 85 and stator tooth 101 have a constant length according to the radial position of the tooth Their longitudinal end surfaces are all perpendicular to axis XX. On the other hand, the length of aerodynamic profile wall 92 of downstream aerodynamic appendage 90 depends on the radial position thereof having a length which is not constant and varies depending on the radial position. The upstream longitudinal end surface, in the direction of flow of the fluid, of aerodynamic profile wall 92 is perpendicular to axis XX. On the other hand, the downstream longitudinal end surface, in the direction of flow of the fluid, of aerodynamic profile wall 92 is not perpendicular to axis XX. Preferably, the length of aerodynamic profile wall 92 of downstream aerodynamic appendage 90 decreases when its radial position increases. The length of aerodynamic profile wall 92 of downstream aerodynamic appendage 90 is the greatest at the inner radius thereof; the smallest length of aerodynamic profile wall 92 of downstream aerodynamic appendage 90 is at the greatest radius thereof. This feature improves the circulating fluid flow at the electrical machine outlet while limiting disturbances and pressure drops. This is particularly interesting when a compressor is arranged just at the electrical machine outlet. The fluid flow entering the compressor thus provides an optimal compressor efficiency.

1-17. (canceled)

18. An electrical machine comprising a rotor and a stator which includes radial passages circumferentially arranged along the stator, the radial passages being delimited by radial teeth, magnetic flux generators housed in the radial passages, the radial passages comprising fluid circulation galleries facing the magnetic flux generators, wherein the electrical machine comprises at least one aerodynamic appendage, the at least one aerodynamic appendage is coaxial with the electrical machine, and is configured at a longitudinal end of the electrical machine, the at least one aerodynamic appendage comprising at least a first part for guiding fluid passing through the circulation galleries, and at least a second part extending radially along at least one of the radial teeth and including an axial direction of the electrical machine and an aerodynamic profile for guiding the fluid.

19. An electrical machine as claimed in claim 18, wherein the at least one aerodynamic appendage is a material with reduced thermal resistance.

20. An electrical machine as claimed in claim 18, wherein the fluid is air.

21. An electrical machine as claimed in claim 18, wherein the at least one aerodynamic appendage includes an asymmetrical profile along a median plane of the at least one aerodynamic appendage.

22. An electrical machine as claimed in claim 18, wherein the at least one aerodynamic appendage is manufactured.

23. An electrical machine as claimed in claim 18, wherein each of the at least one aerodynamic appendage each is configured as at least one removable element.

24. An electrical machine as claimed in claim 18, comprising two aerodynamic appendages configured at longitudinal ends of the electrical machine.

25. An electrical machine as claimed in claim 24, wherein a second part of the at least one aerodynamic appendage is positioned at a longitudinal end of the radial teeth located at an inlet of the fluid in the circulation galleries and has a semi-circular profile in a section orthogonal to a radial direction of the radial teeth.

26. An electrical machine as claimed in claim 18, wherein the at least one aerodynamic appendage is positioned at a longitudinal end of the radial teeth located at the inlet of the fluid in the circulation galleries and comprises a central ogive is of elliptical shape having an order of at least three.

27. An electrical machine as claimed in claim 26, wherein the ogive comprises openings allowing passage of the fluid.

28. An electrical machine as claimed in claim 27, wherein the openings of the ogive guide air flow in an air gap.

29. An electrical machine as claimed in claim 27, wherein the openings have dimensions smaller than a thickness of the air gap.

30. An electrical machine as claimed in claim 28, wherein the openings have dimensions smaller than a thickness of the air gap.

31. An electrical machine as claimed in claim 25, wherein the second part of the aerodynamic appendage, when the aerodynamic appendage is positioned at the longitudinal end of the radial teeth located at the outlet of the fluid from the circulation galleries, is a profile having a thickness, in a section perpendicular to a radial direction of the radial teeth which decreases longitudinally with a greatest thickness being located at a longitudinal end of the radial teeth.

32. An electrical machine as claimed in claim 18, wherein the at least one aerodynamic appendage, positioned at the longitudinal end of the radial teeth located at the inlet of the fluid in the circulation galleries, has a longitudinal dimension varying depending on the radial position thereof, which longitudinal dimension decreases when a radial position increases.

33. An electrical machine as claimed in claim 18, wherein the at least one aerodynamic appendage, positioned at a longitudinal end of the radial teeth located at an inlet of the fluid in the circulation galleries includes mobile aerodynamic flaps and with an associated control system and the mobile aerodynamic flaps providing direction to the fluid at the outlet of the electrical machine.

34. A compression device for a gaseous or liquid fluid, comprising a means for compression with an intake for the fluid to be compressed, an outlet for the compressed fluid, the means for compressing the fluid being carried by a compressor shaft which is housed between the intake and the outlet, in an electrical machine as claimed in claim 18, the electrical machine being positioned upstream, in relation to a direction of flow of the fluid, from the means for compressing.

35. An electrified turbocharger device comprising means for expanding and a compression device as claimed in claim 34, the means for expanding and the compression device being fastened to a same rotating shaft, to provide common rotation of the means for expanding and the compression device.

36. An electrical machine in accordance with claim 19 wherein the material is a polymer.

37. An electrical machine in accordance with claim 22 wherein the at least one aerodynamic appendage is molded.
